(19) United States
(12) Patent Application Publication
(10) Pub. No.: US 2025/0184004 A1
(43) Pub. Date: Jun. 5, 2025

(54) AMPLIFICATION METHOD IN A PON ACCESS NETWORK, COMPUTER PROGRAM PRODUCT, CORRESPONDING OPTICAL LINE TERMINATION DEVICE

(71) Applicant: Orange, Issy-les-Moulineaux (FR)

(72) Inventor: Gael Simon, Chatillon (FR)

(21) Appl. No.: 18/840,334

(22) PCT Filed: Feb. 7, 2023
(86) PCT No.: PCT/EP2023/052979

§ 371 Date: Aug. 21, 2024

(30) Foreign Application Priority Data
Feb. 22, 2022 (FR) FR2201585

(51) Int. Cl. H04B 10/293; H04B 10/272; H04B 10/297; H04J 14/02

(52) U.S. Cl. CPC H04B 10/2931; H04B 10/272; H04B 10/2971; H04J 14/023

(57) ABSTRACT

An amplification method intended for a PON access network, which includes an OLT with multiple ports and with one bidirectional amplifier per port that is shared for the transmission downlink and uplink, at least one ODN connecting a given port of the OLT to a plurality of ONUs and defining a transmission channel, access to the transmission channel for the uplink being of TDMA type and the transmission channel for the downlink being time-shared. The method includes, for a given ODN: receiving bursts from the ONUs, modulating the gain of the amplifier in synchronicity with the received bursts.

### CROSS-REFERENCE TO RELATED APPLICATIONS

This Application is a Section 371 National Stage Application of International Application No. PCT/EP2023/052979, filed Feb. 7, 2023, and published as WO 2023/161016 A1 on Aug. 31, 2023, not in English, which claims priority to French Patent Application No. 2201585, filed Feb. 22, 2022, the contents of which are hereby incorporated by reference in their entireties.

### FIELD OF THE INVENTION

The field of the invention is that of optical (fiber-optic) telecommunications and access networks of “passive optical network” (PON) type. In this field, the invention relates more particularly to an amplification method intended for such a network of PON type. It applies notably to an optical line termination equipment.

A passive optical network (PON) denotes a fiber-optic transport principle used in optical access networks (FTTx, “Fiber To The x”). It is characterized by a passive point-multipoint fiber architecture (several users share a same optical fiber and there is no active equipment between the central facility and the subscribers). There are various PON network standards, including GPON (ITU-T G.984 standard) XGS-PON (ITU-T G.9807 standard), NG-PON2 (ITU-T G.989 standard), HS-PON (ITU-T G.9804 standard), etc. These different access networks are called PON networks or networks of PON type.

### PRIOR ART

An access network of PON type, illustrated by FIG. 1, comprises an optical line termination (OLT) equipment which is linked to optical network units (ONUs), via one or more optical distribution networks (ODNs) of point-multipoint type.

The OLT equipment is the termination equipment, on the network side, ensuring the interface with the fibers of one or more ODN networks. In France, it is generally situated in the optical connection node (NRO) and often located in a so-called central building. It traditionally has a frame with circuit boards each comprising optical ports. An optical port can address several tens of clients, commonly 64, via an ODN network which comprises a splitter/combiner S/C. An OLT equipment can for example comprise more than a hundred or so optical ports respectively linked to as many ODN networks to address several thousands of ONU units.

Each ONU unit ensures the interface on the user side. It converts the optical signals received via a fiber into electrical signals which are then sent to individual subscribers. It is also sometimes called “optical network termination” (ONT).

Each ODN network provides the optical transmission medium for the physical connection of a plurality of ONU units to the OLT equipment, with a range for example limited to 20 km. The ODN network provides the optical channel for the transmission of the optical signals between the OLT and the ONUs in both upstream and downstream directions.

A given ODN network therefore establishes a transmission channel between the given port of the OLT equipment and each of the ONU units addressed, followed both in the downstream direction (referenced “D” in FIG. 1 for “downstream”, that is to say “OLT to ONU”) and in the upstream direction (referenced “U” in FIG. 1 for “upstream”, that is to say “ONU to OLT”).

Although an optical fiber is generally dedicated to a single direction, downstream or upstream in the core network, a single optical fiber is used for the downstream direction and for the upstream direction in the case of an access network of PON type between the OLT and a splitting point also called pooling point. This pooling point corresponds in the downstream direction to the splitting of the optical fiber into several optical fibers implemented by a splitter and in the downstream direction to the grouping together of the optical fibers originating from the different ONU units into a single fiber implemented by the same so-called combiner device. This splitter/combiner device S/C is passive, so it therefore divides the strength of the downstream signal into as many output optical fibers. Depending on the deployment constraints, several splitter/combiners S/C can follow one another.

As illustrated by FIG. 2a for an access network of PON type, the access to the channel in the downstream direction follows a TDM (Time Division Multiplexing) access between the clients addressed according to a temporal cycle and the optical signal transmitted with an amplitude that is continuous in time. Indeed, even in the absence of data to be transmitted and to be addressed to a client, the OLT transmits known strings of 0s and 1s.

As illustrated by FIG. 2b for an access network of PON type, the access to the channel in the upstream direction is divided between the ONU according to a TDMA (Time Division Multiple Access) access.

The transmission from an ONU is performed in the form of bursts. A burst is a sequence of binary data with a header and a data field (payload). A burst has a duration which can vary from a few nanoseconds (ns) to a few hundreds of microseconds (μs).

The rise in the bit rate in a PON access network (with for example in-line bit rates greater than 10 Gbit/s) increases the constraints and notably the difficulties in achieving a certain range for the transmitted signals, meaning with a certain reception quality, whether that be in the downstream direction (from the OLT equipment to the ONU unit) or in the upstream direction (from the ONU unit to the OLT equipment).

To ensure that the optical signal can be received by the ONUs and by the OLTs with a sufficient strength, it is known practice in the field of optical transmissions to use an optical amplifier.

Given that the optical access network incurs numerous investments, changes to it to ensure an increased bit rate can rely on a reworking of the fibers already deployed and in particular those of the access network, the deployment of which is very costly. Thus, the deployment of changes can be done according to particular configurations to limit the costs.

Thus, and as illustrated by FIG. 3, one of these configurations consists in using a common optical amplifier Amp between all the links handled by an optical port of an OLT to which a given ODN corresponds, and doing so equally for the upstream direction and for the downstream direction.

To cover the different wavelengths transmitted in the downstream direction and in the upstream direction, the amplifier Amp is preferably chosen with a gain G that is relatively flat over the band comprising these wavelengths, that is to say with a bit rate variation of at most 3 dB.

The optical amplifiers of SOA (Semiconductor Optical Amplifier) type are particularly suited to the demands of such a configuration.

FIG. 4 illustrates the simplified structure of an optical amplifier of SOA type. As illustrated, an SOA amplifier has an amplification gain that can be controlled by a pumping current intensity Ip. The SOA amplifier amplifies the input signal Se to supply the output signal Ss. FIG. 5 represents the gain of an SOA amplifier as a function of the strength of the input signal for different pumping current values. This figure shows the gain variation of the SOA amplifier as a function of the pumping current. FIG. 6 illustrates the phenomenon of cross-gain modulation which occurs in a PON access network configured with a common optical amplifier Amp for a given optical port of the OLT. The OLT comprises a transmitter Tx (laser transmitter for example) which receives as input a signal to be transmitted. The OLT comprises a receiver Rx of the upstream signal and an optical multiplexer/demultiplexer MUX/DEMUX of the upstream signal and of the downstream signal, for example a dichroic filter. Each ONU unit, for example ONU1, comprises a transmitter Tx1, a receiver Rx1 and an optical multiplexer/demultiplexer MUX/DEMUX1 of the downstream signal received and of the upstream signal transmitted by the ONU. The ODN network defines an optical channel which links, in the downstream direction, the transmitter Tx situated in the OLT equipment to each receiver Rx situated in the ONU units. The optical receiver Rx (photodiode for example) included in the ONU unit receives the signal at the output of the optical channel and generates an output signal to the client. The splitter is identified as the pooling point PM. The optical signal 1U upstream from an ONU unit takes the form of bursts.

The point-to-multipoint nature of the PON network and its massive use (millions of clients) involve a wide variety of OLT/ONU distances and therefore a wide variety of transmission channels. The earlier PON network generations (notably G-PON, XGS-PON and NG-PON2) have hitherto provided interoperability for a transmission channel of a distance lying within a 0-20 km range (that is to say that can be between 0 and 20 km, without prior knowledge).

The upstream signal resulting from the multiplexing of the signals from the active ONU units thus has guard times which can be variable between the bursts and amplitudes which can be different between the bursts given that the distances traveled by the upstream signals between the ONUs and the combiner can be different and given that the upstream signals from the ONU units do not originate from the same transmitter or follow the same fiber to the combiner.

On reception of the upstream signal by the OLT, the gain of the optical amplifier is invoked only periodically by this upstream signal, i.e. for each burst present in the signal and for different values between the bursts as a function of the losses undergone by these bursts from the ONU units.

In the downstream direction, the envelope of the optical signal 2D is continuous, that is to say that it does not take the form of bursts. However this downstream optical signal undergoes temporal gain variations induced by the simultaneous crossings of upstream bursts in the common optical amplifier. These variations are visible on the downstream signal 3D at the output of the amplifier. This phenomenon called “cross-gain modulation” (XGM) is like an interference phenomenon on the downstream signal which is manifested by amplitude variations of this signal and which more particularly impacts the reception performance levels associated with this signal.

### SUMMARY OF THE INVENTION

The invention proposes an amplification method, the objective of which is to improve the implementation of a bidirectional amplifier that is common to the upstream direction and to the downstream direction hosted in an OLT equipment for an access network of PON type.

One subject of the invention is an amplification method intended for an access network of passive optical network type comprising an optical line termination device with several ports and having a variable gain bidirectional amplifier for each port that is common to the downstream direction and the upstream direction of transmission, at least one optical distribution network linking a given port of the optical line termination device to a plurality of optical network units and defining a transmission channel, the access to the transmission channel for the upstream direction being of time-division multiple access type and the transmission channel for the downstream direction being time-divided. The method comprises, for a given optical distribution network:
reception of bursts originating from the optical network units,
modulation of the gain of the amplifier in synchronization with the bursts received.

Also a subject of the invention is an optical line termination device with several ports intended for an access network of passive optical network type comprising at least one optical distribution network linking a given port of the device to several optical network units and defining a transmission channel, the device having a variable gain bidirectional amplifier for each port that is common to the downstream and upstream directions of transmission on the channel. The optical line termination device further comprises, for a given optical distribution network:
at least one receiver of bursts originating from the optical network units with a time-division multiple access to the transmission channel between the units,
a computer for controlling a modulation of the gain of the amplifier in synchronization with the bursts.

The modulation in time of the gain of the amplifier in synchronization with the reception of a burst ensures an adaptation of the gain of the amplifier to offset the discontinuous nature of the upstream signal and its interference on the downstream signal because of the common amplifier. The inherent lowering of energy that the upstream signal exhibits between two consecutive bursts allows the downstream signal to benefit from all the amplification gain between two bursts. However, in the passage of a burst, the amplification gain is divided between the upstream signal and the downstream signal. Consequently, the downstream signal which has a continuous form at the input of the amplifier has form breaks at the output of the amplifier because of this sharing of the gain. The increase in the gain of the amplifier in the passage of a burst benefits the downstream signal during this passage with the lowering, even the elimination, of the interference initially caused by the non-continuity of the upstream signal and its discontinuous invocation of the gain. The gain is then reduced after the end of the burst.

According to one embodiment of the invention, the modulation of the gain is obtained by controlling a power supply current of the amplifier. Thus, the modulation is performed through the electrical current applied to the amplifier.

This embodiment is particularly suited to an amplifier of SOA type according to which the variations of the pumping current lead to variations of the gain.

According to one embodiment of the invention, the modulation of the gain depends on the strength of the burst.

This embodiment is more particularly suited to a deployment of a PON network according to which the optical network units are located at respective distances from the optical line termination device which are different to one another. The distance differences then lead to differences on the respective strengths of the bursts received from different units. Taking into account the received strength makes it possible to best adjust the gain between the bursts originating from different ONU units and to fight more effectively against the cross-gain phenomenon.

According to one embodiment of the invention, the access network being associated with a certain bandwidth in the upstream direction, the method further comprises:
determination of a map of distribution of the bandwidth between the different optical network units by the optical line termination device with identification of a start and time of transmission for the optical network units,
transmission of the bandwidth distribution map to the different optical network units,
   and the method is such that the synchronization between the modulation and the reception of the bursts takes account of the map.

Thus, the optical line termination device OLT knows the instants at which the bursts are transmitted. If the optical network units ONU are at identical distances from the OLT then these instants correspond to the instants of arrival with a delay that is very easy to determine knowing the distance from an ONU to the OLT. This distance can for example be a parameter of the optical line termination device entered upon the deployment of the PON network. If the optical network units ONU are at different distances from the OLT then known methods for determining these distances can be implemented. Knowing each of these distances, the OLT then easily obtains the times of arrival of the bursts by correcting their times of transmission with the time of travel of the respective distances. Thus, the optical line termination device knows, in all cases, the instants of arrival of the bursts and can easily synchronize the adaptation of the gain of the amplifier with these arrivals.

According to one embodiment of the invention, the amplifier is an SOA amplifier whose gain can be adjusted through the control of a current.

According to one embodiment of the invention, the computer is adapted to determine the strength of the bursts received and adapt the driving of the gain as a function of this strength.

### LIST OF THE FIGURES

Other features and advantages of the invention will become more clearly apparent on reading the following description of embodiments, given as simple illustrative and nonlimiting examples, and the attached drawings, in which:

FIG. 1, already described in relation to the prior art, is a diagram of a PON access network,

FIG. 2a, already described in relation to the prior art, illustrates a TDM access to the channel in the downstream direction in a PON network,

FIG. 2b, already described in relation to the prior art, illustrates a TDMA access to the channel in the upstream direction in a PON network,

FIG. 3, already described in relation to the prior art, illustrates an access network of PON type with a bidirectional amplifier common to the OLT,

FIG. 4, already described in relation to the prior art, is a diagram of a bidirectional amplifier of SOA type,

FIG. 5, already described in relation to the prior art, contains curves of the gain as a function of the strength of the input signal of a bidirectional amplifier of SOA type for the different pumping current values,

FIG. 6, already described in relation to the prior art, is a diagram of an access network of PON type to which has been added a temporal representation of the upstream signal transmitted by an ONU unit, of the downstream signal with wavelength multiplexing with the upstream signal, and of the downstream signal after amplification by the bidirectional amplifier,

FIG. 7 is a diagram of an access network of PON type comprising a bidirectional amplifier with control of the amplification gain according to the invention and showing the simplified structure of an OLT according to a particular embodiment of the invention, configured to implement an amplification method according to the invention, to which has been added a temporal representation of the upstream signal transmitted by an ONU, of the downstream signal before wavelength multiplexing with the upstream signal, and of the downstream signal after amplification by the bidirectional amplifier

FIG. 8 is a curve representative of the gain as a function of the wavelength of a bidirectional amplifier of SOA type,

FIG. 9 is a flow diagram of an embodiment of an amplification method according to the invention.

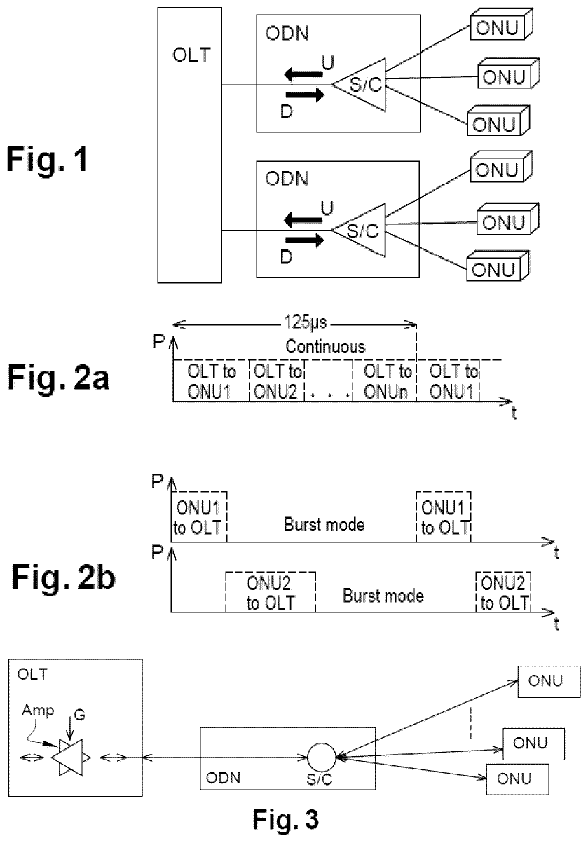

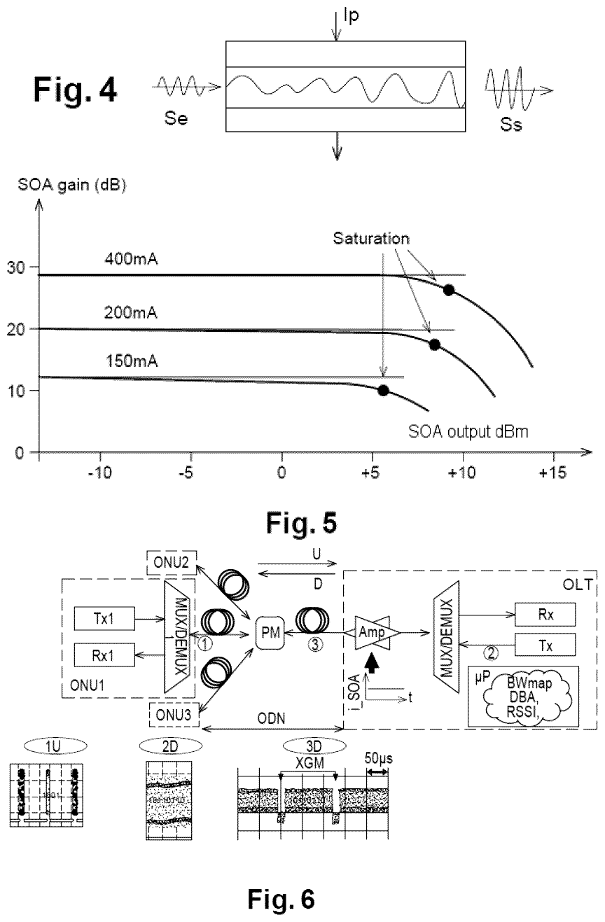

### DESCRIPTION OF PARTICULAR EMBODIMENTS

In all the figures of the present document, the elements and steps that are identical are designated by a same alphabetical or numerical reference.

The invention lies within the context of an access network of PON type, that is to say according to a passive point-multipoint fiber architecture between the OLT and the ONUs. There is therefore no active element in the ODN which makes the link between a port of the OLT and the ONUs that are recipients from this port, and this is so, more particularly, for reasons of cost. Furthermore, the access to the downstream channel corresponds to a TDM (Time Division Multiplexing) scheme and the access to the upstream channel corresponds to a TDMA (Time Division Multiple Access) scheme under the control of the OLT.

In this context, the general principle of the invention relies on a control of the gain of the bidirectional amplifier of the OLT in temporal synchronization with the reception of an upstream burst and as a function of the energy of this burst.

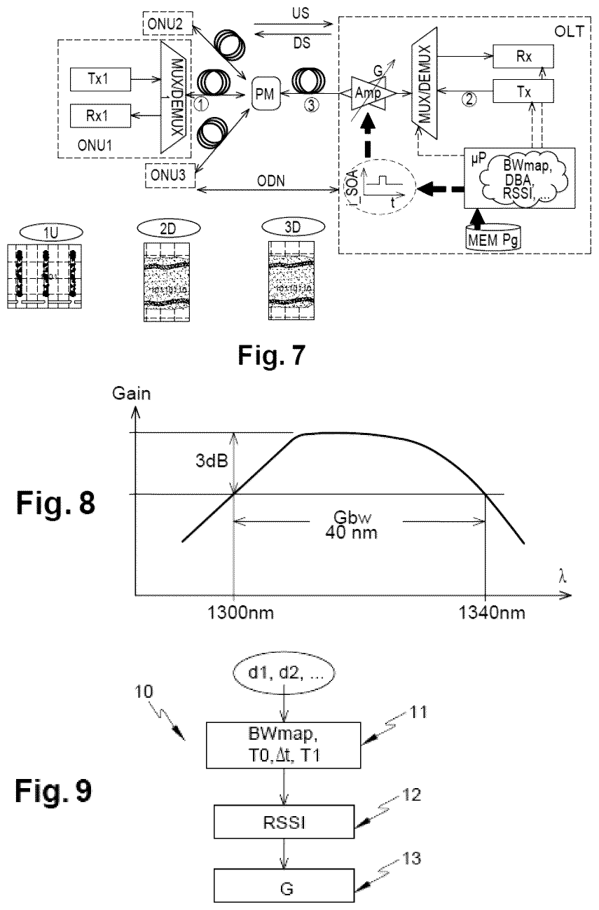

FIG. 7 is a diagram of an access network of PON type comprising a bidirectional amplifier common to the upstream direction and to the downstream direction with control of the amplification gain according to an embodiment of the invention.

This access network of PON type comprises at least one OLT equipment with at least one optical port, several similar ONU units, ONU1, ONU2, ONU3, and an ODN network for each optical port of the OLT equipment.

The OLT equipment comprises, for each optical port, a transmitter Tx of the downstream signal, a receiver Rx of the upstream signal and an optical OADM multiplexer/demultiplexer of the upstream signal and of the downstream signal.

Each unit, ONU1, comprises at least one transmitter Tx1, a receiver Rx1 and an optical multiplexer/demultiplexer MUX/DEMUX1 of the downstream signal and of the upstream signal originating from the unit, ONU1.

Each transmitter Tx, Tx1 is, for example, a laser diode. The transmitter Tx of the OLT equipment receives as input a signal comprising data to be transmitted to one or more units ONU1, ONU2, ONU3. This input signal is for example a bit train in the NRZ format and with a bit rate of several tens of Gb/s. The optical multiplexer/demultiplexer MUX/DEMUX1 is for example of OADM, Optical Add and Drop Multiplexer, type.

The ODN network defines an optical channel which links, in the downstream direction, the transmitter Tx situated in the OLT equipment with each receiver Rx1 situated in the units ONU1, ONU2, ONU3 and, in the upstream direction, the transmitters Tx1 situated in each unit ONU1, ONU2, ONU3 with the receiver Rx situated in the OLT equipment.

The OLT equipment comprises, for a given optical port, a bidirectional optical amplifier Amp common to the downstream direction and to the upstream direction.

According to one embodiment, the amplifier is an optical amplifier of SOA (Semiconductor OpticalAmplifier) type. The SOA amplifier whose gain is represented in FIG. 8 has a bandwidth of between approximately 1300 and 1340 nm. This amplifier is particularly suited to an HS-PON access network.

According to another embodiment, the amplifier is a fiber-optic (Erbium, Praseodymium) amplifier. The amplifier of SOA type has the advantage of being less expensive and more compact than a fiber-optic amplifier.

The OLT equipment comprises a microprocessor μP or equivalent, such as a microprogrammed electronic component whose operation is controlled by the execution of a program Pg whose instructions allow the implementation of an amplification method according to the invention. The program is for example stored in a memory MEM.

The microprocessor μP controls at least the various components via control signals: the bidirectional optical amplifier Amp, the receiver Rx, the transmitter Tx, the optical multiplexer/demultiplexer OADM. The microprocessor μP remotely controls the ONU units via an exchange protocol which is generally transmitted in the transmitted frames (so-called In band protocol).

FIG. 9 gives a flow diagram of an amplification method according to the invention.

On the initialization of the OLT equipment, the code instructions of the programme Pg are for example loaded from the memory MEM into a memory of the microprocessor or into a buffer memory (not represented) before being executed by the microprocessor μP for the implementation of an amplification method 10 according to the invention.

The OLT equipment knows the architecture of the PON network. It knows the distances d1, d2 between each ONU1, ONU2 and the OLT. This knowledge can result from a parameterizing of the OLT equipment or be obtained by implementing a known method (ranging) for determining distances. Thus, by executing the instructions, the microprocessor μP, establishes 11 a map of distribution of the bandwidth Bwmap (Bandwidth map) between the different ONU units.

This map is periodically reassessed so as to allow for a dynamic change of the bandwidth assigned to the ONU units. The OLT regularly assigns more or fewer temporal resources to the ONU units using the dynamic bandwidth assignment (DBA) method which periodically determines the reassessed map. This method generally takes account of the distance from each ONU unit to the OLT, the activity of each ONU unit (an inactive ONU unit has little or no bandwidth) and the QoS parameters assigned to the different clients respectively of the ONU units (contractually, a client can benefit from a service with more or less bandwidth).

The map BWmap can be transmitted in a header of each downstream frame and each recipient ONU extracts from this header the information which relates to it, in particular the instant at which it can begin to transmit T0 in the upstream direction and the authorised transmission time Δt.

The optical signal 1U upstream from an ONU unit takes the form of a burst transmitted during the time Δt assigned to this ONU unit. The map BWmap generated by the OLT thus identifies, for each ONU unit, the instant T0 of start of transmission of a burst and the assigned transmission time Δt. This assignment of an instant T0 and of a time can possibly take the form of the identification of assigned timeslots. The map can possibly define these assignments for several transmission cycles.

The bursts originating from the different time-multiplexed ONU units on the upstream signal can thus be aggregated at the splitter/combiner without there being any collision between the bursts originating from the different ONU units.

The OLT thus orders the multiplexing of the upstream signals from the different ONU units and therefore knows the instant of arrival T1 of a burst since the latter is determined from the map BWmap. The instant of arrival T1 differs from the instant of transmission T0 by the time of travel of the channel between the ONU and the OLT by the transmitted burst.

By executing the instructions, the microprocessor μP drives the receiver Rx to receive, FIG. 9 reference 12, a burst and recover, FIG. 9 reference 12, the strength of this burst. This strength can correspond to the RSSI (Received Signal Strength Indicator) or can be determined by any other equivalent means.

Knowing the instant of arrival of a burst and its strength, the microprocessor consequently modulates 13 the gain G of the amplifier.

Thus, the microprocessor controls the value of the current I_SOA to be applied to an SOA bidirectional amplifier to adapt the gain during the time of this burst. The increase in the gain during the burst is such that it ensures an amplification energy that is sufficient to be divided between the upstream signal and the downstream signal without fluctuation on the downstream signal. At the end of the burst, the gain is reduced.

Thus, with the invention and contrary to the prior art, the downstream optical signal 3D no longer undergoes any temporal variation. The adaptation of the gain of the amplifier by synchronization with the passage of a burst and linked with the strength of this burst makes it possible to distribute the amplification energy between the upstream direction and the downstream direction while absorbing the fluctuations of the upstream signal. The invention makes it possible to effectively fight against the phenomenon of “cross-gain modulation” which impacts the downstream signal.

Consequently, the invention applies also to one or more computer programs, notably a computer program on or in an information medium, suitable for implementing the invention. This program can use any programming language, and be in the form of source code, object code, or of intermediate code between source code and object code, such as in a partially compiled form, or any other desirable form for implementing a method according to the invention.

The information medium can be any entity or device capable of storing the program. For example, the medium can comprise a storage means, such as a ROM, for example a CD ROM or a microelectronic circuit ROM, or even a magnetic storage means, for example a USB key or a hard disk.

On the other hand, the information medium can be a transmissible medium such as an electrical or optical signal, which can be conveyed via an electrical or optical cable, by radio or by other means.

The program according to the invention can in particular be downloaded from an Internet type network.

Alternatively, the information medium can be an integrated circuit in which the programme is incorporated, the circuit being adapted to execute or to be used in the execution of the method concerned.

Although the present disclosure has been described with reference to one or more examples, workers skilled in the art will recognize that changes may be made in form and detail without departing from the scope of the disclosure and/or the appended claims.

1. An amplification method intended for an access network of passive optical network type, comprising an optical line termination device with several ports and having a variable gain bidirectional amplifier for each port common to a downstream direction and an upstream direction of transmission, at least one optical distribution network linking a given port of the optical line termination device to a plurality of optical network units and defining a transmission channel, access to the transmission channel for the upstream direction being of a time-division multiple access type and the transmission channel for the downstream direction being a time-divided type, wherein the amplification method is implemented by the optical line termination device and comprises, for a given optical distribution network of the at least one optical distribution network:
receiving upstream bursts originating from the plurality of optical network units; and
compensating a lowering of energy of a downstream signal induced by passage of the upstream bursts in the bidirectional amplifier by modulating a gain of the bidirectional amplifier in synchronization with the upstream bursts received.

2. The amplification method as claimed in claim 1, wherein modulating the gain comprises controlling a power supply current of the bidirectional amplifier.

3. The amplification method (10) as claimed in claim 1, wherein modulating the gain depends on a strength of the upstream bursts.

4. The amplification method as claimed in claim 1, the access network being associated with a certain bandwidth in the upstream direction, the method further comprises:
determining a map of distribution of the bandwidth between the plurality of optical network units by the optical line termination device with identification of a start and of a transmission time for the optical network units;
transmitting the bandwidth distribution map to the plurality of optical network units,
wherein the synchronization between the modulation and the reception of the upstream bursts takes account of the map.

5. An optical line termination device comprising:
several ports for an access network of passive optical network type comprising at least one optical distribution network to link a given port of the device to several optical network units and define a transmission channel;
a variable gain bidirectional amplifier for each port of the several ports that is common to downstream and upstream directions of transmission on the channel; and
for a given optical distribution network:
at least one receiver of upstream bursts originating from the several optical network units with time-division multiple access on the transmission channel between the optical network units;
a computer configured to compensate a lowering of energy of a downstream signal induced by passage of the upstream bursts in the bidirectional amplifier by controlling a modulation of a gain of the bidirectional amplifier in synchronization with the upstream bursts.

6. The optical line termination device as claimed in claim 5, wherein the amplifier is an Semiconductor Optical Amplifier (SOA) amplifier whose gain can be adjusted by controlling a current.

7. The optical line termination device as claimed in claim 5, wherein the computer is adapted to determine a strength of the upstream bursts received and adapt a driving of the gain as a function of the strength.

8. (canceled)

9. A non-transitory information medium comprising program instructions stored thereon and suited to implement the amplification method as claim in claim 1, when said program is loaded and run in optical line termination device.
